(19) United States
(12) Patent Application Publication
(10) Pub. No.: US 2003/0073242 A1
(43) Pub. Date: Apr. 17, 2003

(54) Apparatus for controlling stripping solutions methods thereof

(76) Inventors: Keith G. Kitchens, Eau Claire, WI (US); James P. Augustine, Chippewa Falls, WI (US); Terrence D. Krueger, Chippewa Falls, WI (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 09/977,886

(22) Filed: Oct. 11, 2001

(51) Int. Cl. G01N 27/00

(52) U.S. Cl. 436/55; 422/62; 422/82.02; 436/111; 422/12; 436/7; 436/13; 436/150; 436/151

(57) ABSTRACT

In a printed circuit board manufacturing process, a resist stripping solution blending organic amines with water is used for stripping the photoresist completely from the board. An apparatus for controlling this resist stripping solution comprises a toroidal conductivity controller for measuring the solution conductivity, which correlates to solution concentration. This same apparatus is equipped with a resist stripping solution discharge device for discharging the resist stripping solution and water replenishing device for replenishing water by detecting the liquid level of the resist stripping solution by a liquid level gauge. As the water is replenished, the solution conductivity is lowered; thereby activating the toroidal conductivity controller to add concentrated resist stripping chemistry proportionally to the deviation from the conductivity controller set point. This same apparatus is equipped with a measuring device for measuring the total consumed organic amine reactants. The organic amine reactant device has a set point to trigger the resist stripping solution discharge device. In this fashion the resist loading level can be controlled. As a result, in an apparatus for controlling a resist stripping solution used in the manufacture of printed circuit boards, the quality of the resist stripping solution is controlled constantly, the solution consumption is minimized, the operational down time is reduced, and the cost is lowered.

### FIELD OF THE INVENTION

The field of the invention is electronic components and printed circuit boards.

### BACKGROUND OF THE INVENTION

Electronic components are used in ever increasing numbers of consumer and commercial products. The demand for the electronic components, and subsequently the products that contain these components, that can be efficiently and reliably produced is also increasing, as more consumers and companies incorporate electronic products into their lives and businesses.

In order to increase efficiency in the production of electronic components, the production and makeup of these components are studied to determine if there could be better processes or apparatus for designing and constructing the component. Some of the processes that can be investigated and potentially improved upon are a) the process of depositing layers of materials to form the component, b) the process of forming patterns of materials on or in the electronic component by either patterned deposition or resist stripping, and c) the curing process of the component.

One problem in forming patterns through resist stripping of a surface is the chemical complexity of stripping solutions. A typical stripping solution can simultaneously comprise several chemical compounds or solutions, including monoethanolamine (MEA), tetramethyl ammonium hydroxide (TMAH), 2-hydroxyethyl-trimethyl ammonium hydroxide (choline, also known as a “phase transfer catalyst”), methyl alcohol, ethylenediamine, and 2-propoxyethanol. U.S. Pat. No. 4,686,002 issued to Tasset (August 1987) discloses one such class of complex choline solutions that comprises a collection of “stabilizing” solutions, such as formaldehyde or paraformaldehyde, that can prevent the decomposition of the choline base. Choline base decomposition is a major problem, according to Tasset, when using choline as a stripping solution without stabilizers because of the release of triethylamine into the stripping solution, which causes the stripping solution to become severely discolored and potentially significantly weaker. Choline base solution is also quite expensive (about 10 times more costly than MEA per square foot of resist stripped). Therefore, any method that can extend the life span of choline solution is desirable for a cost-efficient stripping process.

Because of the complexity of the solution, it can be difficult to maintain the concentration of a stripping solution throughout a large scale stripping procedure, such as that procedure that might be needed to process a large number of printed circuit boards or layered materials. The complexity of the stripping solution is not only based on the number of components in the stripping solutions, but also the way the components are consumed in the stripping process. For example, in a solution comprising choline and MEA, the MEA will remain essentially unreacted until all of the choline is consumed. Thus, maintaining and monitoring all of the chemical components of the original stripping solution at constant concentrations while introducing the stripped chemicals into the solution and monitoring and controlling the pH of the solution presents a difficult problem, especially in light of the desire for additional automation in the production of electronic components.

Another problem in forming patterns through resist stripping of a surface is that the chemical effectiveness of stripping solutions deteriorates over time and during use in photoresist processing. A stripping solution that is initially designed to strip the tough outerlayers of a circuit board weakens after about 20% of its “life span” and becomes only efficient enough to strip the innerlayers for the last 80% of its life span. Stripping solutions deteriorate, in general, because a) the alkaline organic amine of the typical stripping solution reacts with the acid in the photoresist, b) the amine in the solution reacts with carbon dioxide and oxygen gas in the atmosphere, and c) there's no useful or efficient real time method to replenish or control the concentration and integrity of the stripping solution.

A conventional method of preparing and refreshing a typical stripping solution is: a) filling a stripping processing tank with the specified volume of a fresh stripping solution at a specified concentration, b) determining when the stripping solution is consumed and reaches a specific deterioration concentration region by using an empirical index—such as the number of boards processed, and c) activating a feed and bleed system that adds a premixed stripping solution to the working resist stripping solution. This method is not as sensitive and accurate as desired because the empirical index does not take into account the chemical properties of the solution or the conductivity of the solution, per se, but instead takes into account the amount of “work” done by the solution.

The photoresist as a function of contact with the stripping solution slowly dissolves in the stripping solution and in turn changes the absorption qualities of the stripping solution. Nakagawa et al. in U.S. Pat. No. 5,223,881 (issued on Jun. 29, 1993); U.S. Pat. No. 5,671,760 (issued on Sep. 30, 1997); and U.S. Pat. No. 5,896,874 (issued on Apr. 27, 1999) takes advantage of the change in the absorption qualities of the stripping solution to monitor when the original stripping solution should be replenished with fresh chemicals. The theory in Nakagawa is that as choline base decomposes and as resist materials are removed and added to the stripping solution the difference in the total light that can pass through the used solution versus a fresh solution can be measured and quantified using an absorption photometer. Once the measurement from the absorption photometer reaches a certain pre-set value, fresh stripping solution is added to the used stripping solution in order to bring the stripping solution back to an efficient stripping performance level. Therefore, the Nakagawa method merely measures a physical property of the solution and does not focus on a chemical or electrical property of the stripping solution.

In order to minimize the addition of fresh and sometimes expensive stripping chemicals in the Nakagawa method, a solution filtering device could also be attached to the stripping solution processing equipment to remove resist that has been stripped but not dissolved. However, the efficiency of the filtration device and the turn-over rate of the stripping solution determines the effective resist contact time with the solution.

An additional production problem is the use of multi-thickness photoresist. In most commercial printed circuit board manufacturing processes, there is not one photoresist thickness that satisfies all production requirements. Since typical feed and bleed replenishment systems are set up with one photoresist thickness or an average thickness for multi-thickness photoresist, the feed and bleed systems do not adjust for multi-thick photoresists. This condition creates the need to manually analyze the concentration via titration on an increased frequency and is very costly to operate.

Thus, there is a continuing need to a) logically determine the proper combination of materials for a suitable stripper solution depending on the needs of the customer, b) operate an efficient and reliable apparatus for stripping photoresists using the formulated stripping solution and c) simultaneously, consistently and automatically control the formulated stripping solution based on a set of predetermined parameters.

### SUMMARY OF THE INVENTION

An apparatus for monitoring and controlling a stripping solution comprises: a) a stripping solution contained in a sump, b) a toroidal conductivity controller system coupled to the sump, c) a charge counter device coupled to the controller, d) a pump system operatively coupled to the charge counter device, and e) a level control system operatively coupled to the pump system and the solution.

In a preferred embodiment, the apparatus controls an alkaline organic amine stripping solution used in stripping a photoresist from a printed circuit board in an electronic component or printed circuit board manufacturing process or the like.

In yet another preferred embodiment, the apparatus and related method combines a continuous automatic replenishing mechanism to replenish the alkaline organic amine stripping solution, an alkaline reactant regulating mechanism, and a resist stripping solution automatic discharge mechanism for discharging dissolved photoresist and thus arresting deterioration of the stripping performance of the stripping solution.

In still yet another embodiment, the advantages of a convenient line conveying system suited to mass production in the printed circuit board manufacturing processes can be maintained.

In other words, it is preferred to a) automatically control the stripping solution by controlling the specific alkaline organic amine concentration and the relative effects of dissolved photoresist materials on the amine concentration, b) control the solution replenishment in the stripping processing tank, and c) reduce the comprehensive manufacturing cost of the stripping process.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a schematic diagram of a preferred embodiment of the invention.

FIG. 2 shows a typical charge versus time graph for calculating the charge used by the charge counter device.

FIG. 3 is a schematic diagram of an apparatus for controlling photoresist-stripping solution showing a preferred embodiment of the invention.

FIG. 4 is a graph of an operation example showing the relationship between solution conductivity, pH, and concentration for a commercially available resist stripping solution at 51.7° C., Electrochemicals™ RS-8017Q.

FIG. 5 is a graph of an operation example showing the relationship between solution conductivity, pH, and concentration for a commercially available resist stripping solution at 25° C., Electrochemicals™ RS-8017Q.

FIG. 6 is a graph of an operation example showing the relationship between solution conductivity, pH, and concentration for a commercially available resist stripping solution at 51.7° C., Electrochemicals™ RS-8017Q.

FIG. 7 is a graph of an operation example showing the relationship between solution pH, and concentration for a commercially available resist stripping solution at 25° C., Electrochemicals™ RS-8017Q.

FIG. 8 is a graph of an operation example showing the relationship between solution pH, and concentration for a commercially available resist stripping solution at 51.7° C., Electrochemicals™ RS-8017Q.

FIG. 9 is a graph of an operation example showing the relationship between solution conductivity, pH, and concentration for a commercially available resist stripping solution at 25° C., Electrochemicals™ RS-8017Q.

FIG. 10 is a graph of an operation example showing the relationship between solution conductivity, DuPont™ MM120 photoresist stripping speed, and DuPont™ MM120 photoresist loading in a production stripping machine with Electrochemicals™ RS-8017Q stripping solution.

FIG. 11 is a graph of an operation example showing the relationship between resist loading and pH; DuPont™ MM120 photoresist loading in a production stripping machine with Electrochemicals™ RS-8017Q stripping solution.

FIG. 12 is a graph of an operation example showing the relationship between resist loading and pH: DuPont™ MM120 photoresist loading in a production stripping machine with Electrochemicals™ RS-8017Q stripping solution.

FIG. 13 is a graph of an operation example showing the relationship between resist loading and stripping speed: DuPont™ MM120 photoresist stripping speed, and DuPont™ MM120 photoresist loading in a production stripping machine with Electrochemicals™ RS-8017Q stripping solution.

FIG. 14 is a graph of an operation example showing the relationship between resist loading and stripping speed (actual component strip rates): DuPont™ MM120 photoresist stripping speed, and DuPont™ MM120 photoresist loading in a production stripping machine with Electrochemicals™ RS-8017Q stripping solution.

FIG. 15 is a graph of an operation example showing the relationship between resist loading, stripping speed and pH: DuPont™ MM120 photoresist stripping speed, and DuPont™ MM120 photoresist loading in a production stripping machine with Electrochemicals™ RS-8017Q stripping solution.

FIG. 16 is a graph of an operation example showing the relationship between resist loading, solution pH, and solution conductivity: DuPont™ MM120 photoresist loading in a production stripping machine with Electrochemicals™ RS-8017Q stripping solution.

FIG. 17 is a graph of an operation example showing the relationship of the solution conductivity, photoresist loading, concentrated stripping solution replenishment solution, and the solution discharge and water replenishment systems.

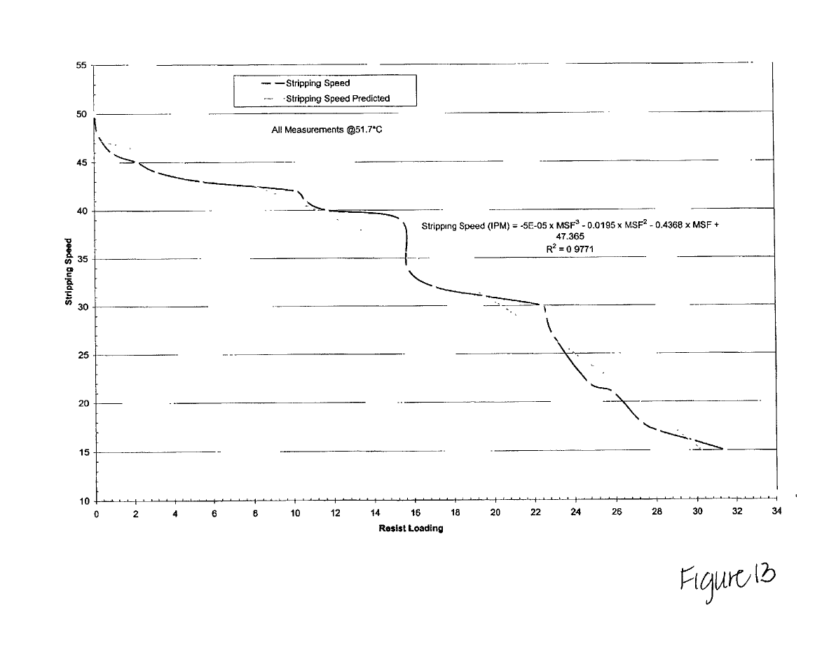

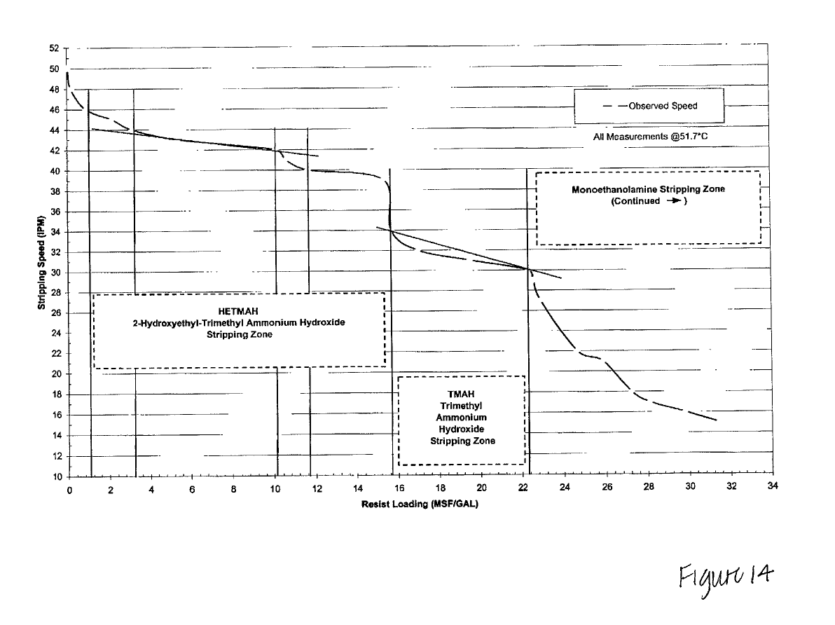

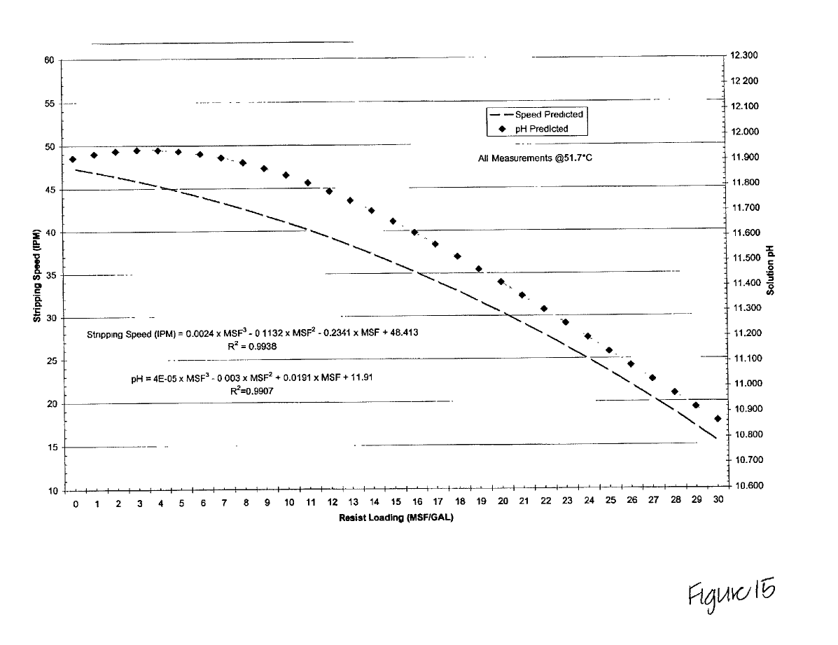

Table 1 shows laboratory analysis raw data and data used for FIGS. 11 and 12.

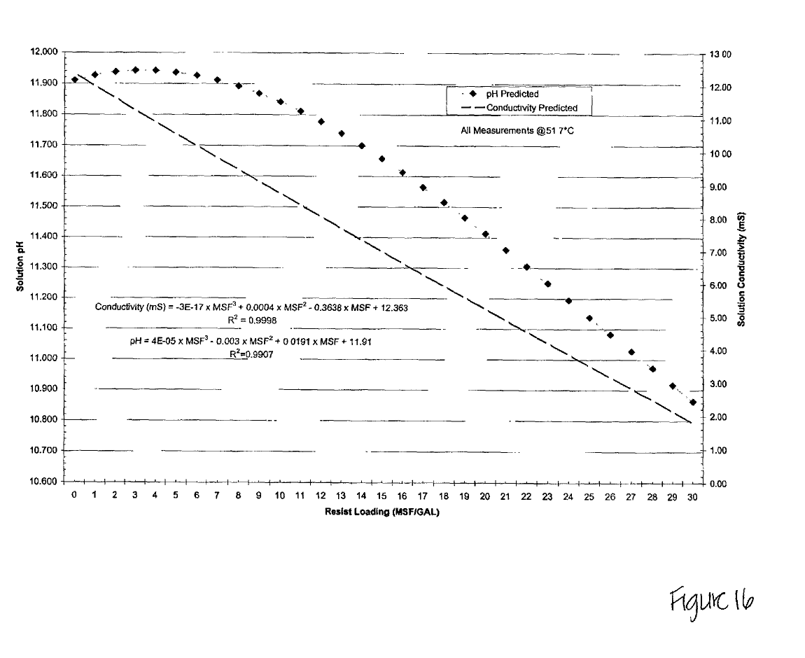

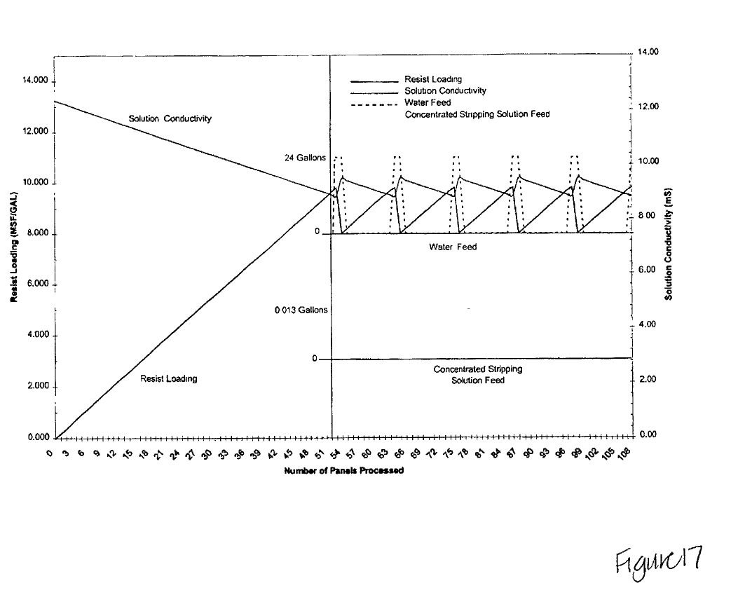

Table 2 shows production testing raw data used in FIGS. 13 and 14.

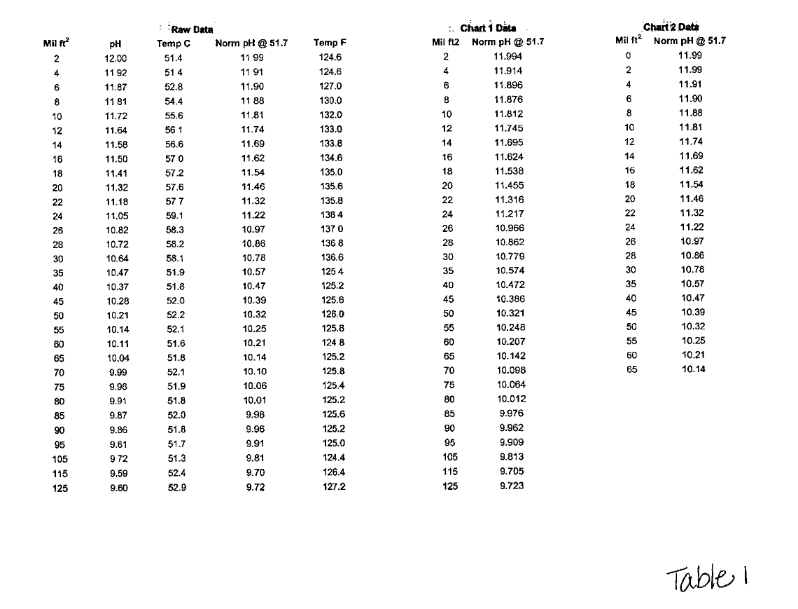

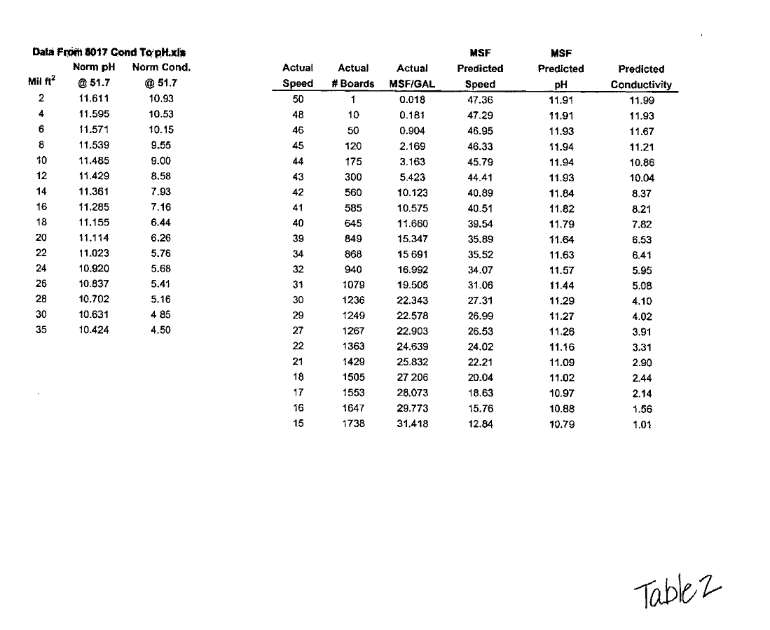

Table 3 shows production testing raw data used in FIGS. 11 through 16.

### DETAILED DESCRIPTION

The apparatus and methods described herein automatically and continuously replenish a resist stripping solution based on the chemical and electrical properties of the stripping solution at any point in time. Also, provided by the present invention there is an alkaline reactant regulating mechanism and a resist stripping solution automatic discharge mechanism for discharging dissolved photoresist and thus arresting deterioration of the stripping performance of the stripping solution. Further, the apparatus and methods described herein advantageously allow for a convenient line conveying system suited to mass production in the printed circuit board manufacturing processes.

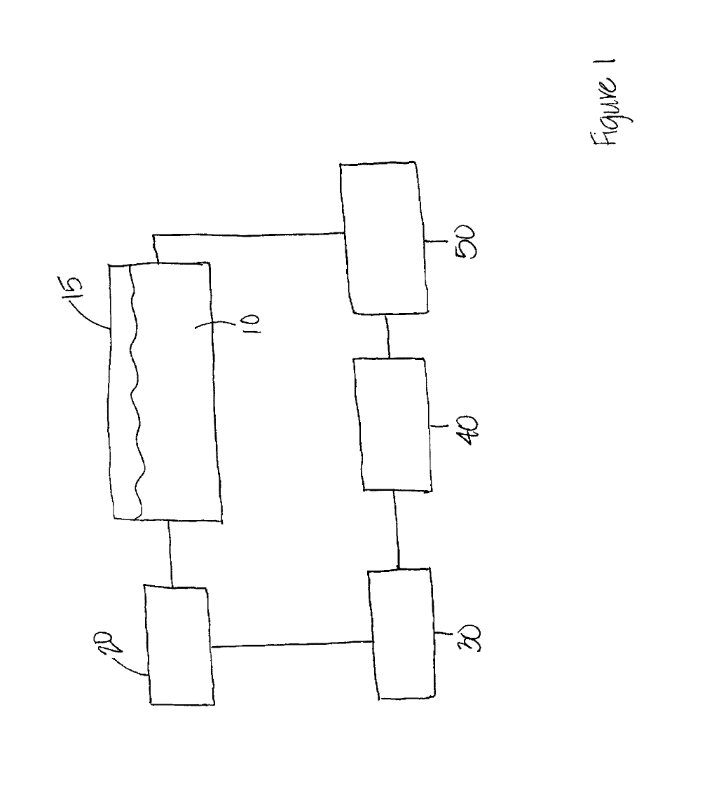

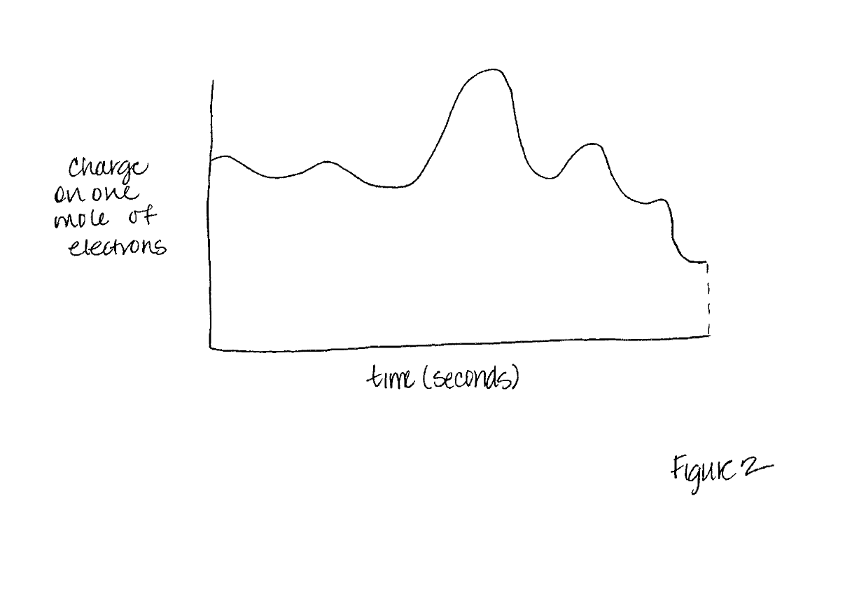

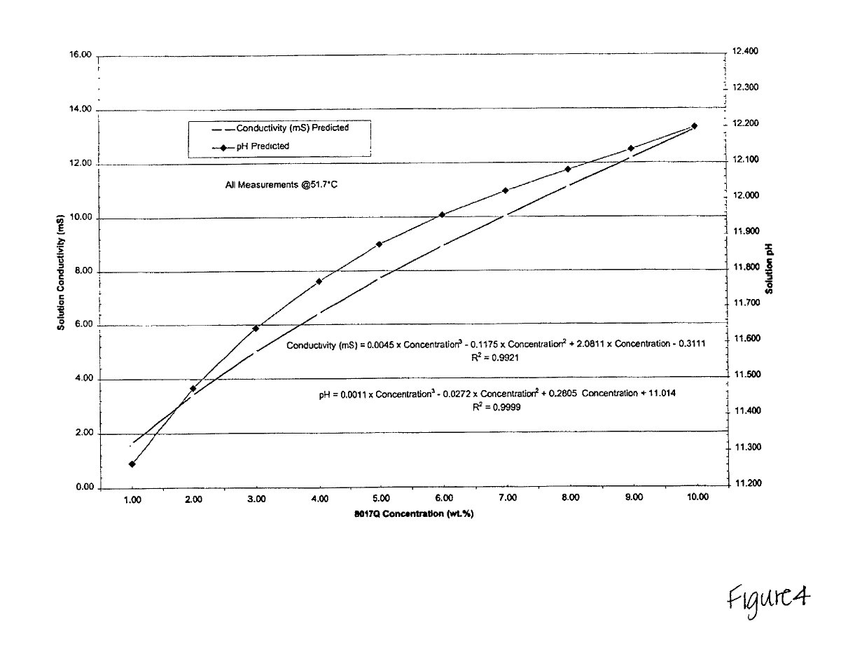

FIG. 1 shows an apparatus, according to one aspect of the present invention, for monitoring and controlling a stripping solution comprising: a) a stripping solution 10 in a container 15, b) a toroidal conductivity controller system 20 coupled to the stripping solution 10, c) a charge counter device 30 coupled to the controller 20, d) a pump system 40 operatively coupled to the charge counter device 30, and e) a level control system 50 operatively coupled to the pump system 40 and the solution 10. The individual components of the apparatus are below described in detail and contemplated methods are described below and are elucidated further in the Examples section. A detailed depiction of the apparatus of the present invention is also shown in FIG. 3, which will be described in detail in the Examples Section.

An ideal stripping solution 10 for the apparatus and methods described herein is designed to effectively and efficiently remove a specific photoresist from a surface through acid/base neutralization. In general, the stripping solution 10 is basic and thus neutralizes the acidic photoresist. A preferred stripping solution 10, therefore, is one that is basic. In other words, a preferred stripping solution 10 comprises components that meet the generally accepted definitions of a Lowry-Brönsted base or Lewis base. Examples of such bases are hydroxyl ion and most anions, metal oxides, and compounds with oxygen, nitrogen, sulfur with non-bonded electron pairs (such as water, ammonia, and hydrogen sulfide). A more preferred stripping solution 10 comprises at least one of the following components: monoethanolamine (MEA), tetramethyl ammonium hydroxide (TMAH), 2-hydroxyethyl-trimethyl ammonium hydroxide (Choline), methyl alcohol, ethylenediamine, 2-propoxyethanol, or their mixtures. A most preferred stripping solution 10 comprises all of the above-mentioned components, including monoethanolamine (MEA), tetramethyl ammonium hydroxide (TMAH), 2-hydroxyethyl-trimethyl ammonium hydroxide (Choline), methyl alcohol, ethylenediamine, 2-propoxyethanol, or their mixtures.

The stripping solution 10 is generally controlled in a container 15, such as a sump, a vat, a drum or a vessel that is accessible by the researcher and that can be modified to fit within an automated system of photoresist stripping. In a preferred embodiment, the container 15 used to hold the stripping solution 10 is made from any material that will not chemically interact or breakdown in the direct presence of the stripping solution 10 or its vapor/fumes. In a more preferred embodiment, the container 15 is made from a silica-based compound, a composite material, a pure metal or a metal alloy. In further preferred embodiments, the stripping solution 10 is contained by a conventional commercial stripper, such as the CHEMCUT Model 547.

The physical conditions of the stripping solution 10 can be controlled by either the researcher or the automated program for the stripping process. The physical conditions of the solution 10 include the temperature, the pressure, or the initial volume. In a preferred embodiment, the temperature of the stripping solution 10 is heated to and maintained at a temperature of at least 100° F. and preferably 125° F. throughout the process at standard atmospheric pressure. The resist stripping solution 10 is typically heated via electric heaters and cooled via chilled water. The temperature of the stripping solution 10, including the electric heaters and chilled water, is preferably controlled by a temperature-regulating device.

A toroidal conductivity controller system 20 generally comprises a toroidal conductivity controller 22, a sensor 24 and a display device 26. The toroidal conductivity controller 22 is designed to measure the conductivity of a solution and adjust the stripper solution concentration to a specified set point. Solution conductivity is a function of ion concentration, ion mobility, and ionic charge. Ions in water conduct current when an electrical potential is applied across electrodes that are immersed in the solution. Solution conductivity, which is the reciprocal of solution resistance, is measured in units of siemens (1 /ohm). The controller 22 uses the sensor 24 to measure the concentration of a component or all of the components of the stripper solution 10 as based on the solution conductivity and then triggers a series of pumps 40 to adjust the concentration of the components of the stripper solution 10. For example, if the alkaline organic amine concentration is the primary concentration to be monitored and adjusted, the toroidal conductivity controller 22 will indirectly monitor the amine concentration by directly measuring the solution conductivity with the sensor 24 and then triggers a set of pumps to adjust the concentration according to preset standards.

A preferred toroidal conductivity controller sensor 24 is one that is highly reliable, corrosion resistant and specifically designed to monitor conductivity, chemical concentration, and/or salinity in varied and sometimes difficult applications where coating, fouling, corrosion, or high temperatures is a concern. Contemplated toroidal conductivity cells or controllers are those disclosed in U.S. Pat. No. 3,806,798 issued to Gross (April 1974) or U.S. Pat. No. 5,157,332 issued to Reese (October 1992). A more preferred sensor 24 is the Honeywell 5000TC Series Toroidal (electrodeless) Conductivity Sensor or the Conductivity/Resistivity HART Analyzer Model 54e C.

A toroidal conductivity controller display device 26 can be any suitable digital or analog display device depending on the needs of the overall process. A preferred display device 26 is digital and capable of displaying a concentration variable to at least 3 decimal places.

As the stripper solution 10 interacts with the photoresist or resist material on a circuit board, substrate or other surface, resist material pulls away from the surface and is introduced into the stripper solution 10. During this process, the chemical concentration of the original stripper solution 10 begins to deteriorate and deviate from the original concentration of that solution 10. The toroidal conductivity controller 22 monitors the difference between the concentration of the original solution 10 and the concentration of the solution at a point in time during the stripping process. The difference between the chemical concentration of the actual solution during stripping and the original concentration is registered by the controller as a “current difference”, which is preferably registered in the current units—milliamps or can be registered in conductivity units—millisiemens.

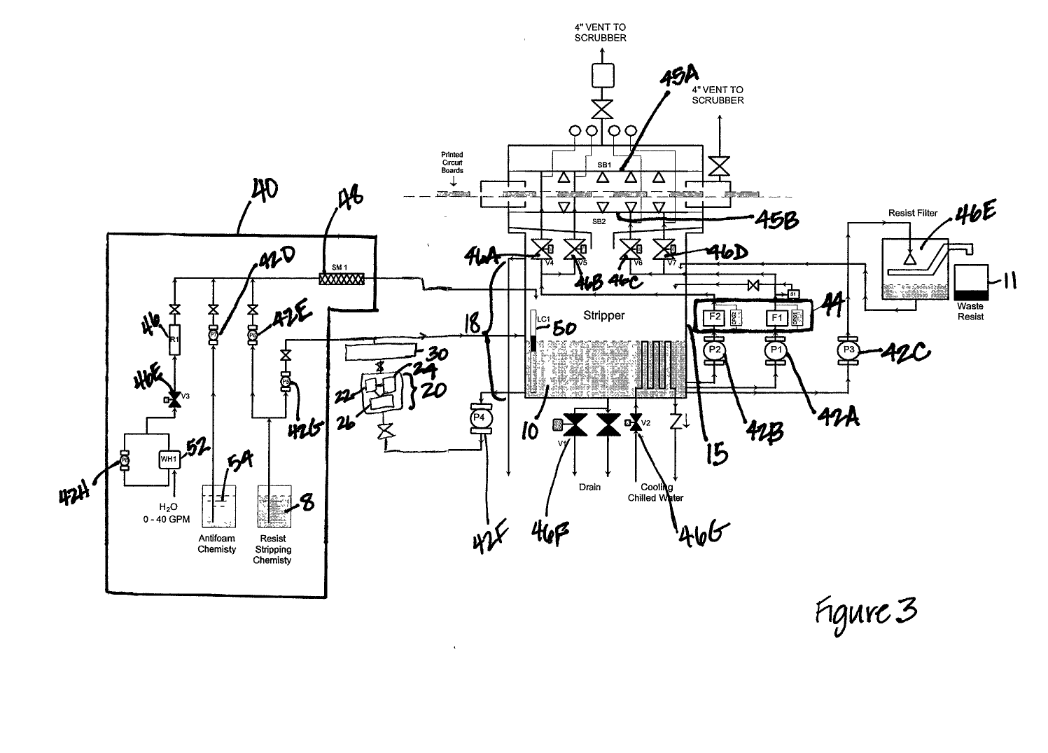

A charge counter device 30 is operatively coupled to the toroidal conductivity controller 22 and measures the “charge difference” or “current difference” at a particular time. FIG. 2 shows a typical charge versus time graph that might be used for this type of calculation. The charge counter device 30 accumulates the total milliamp signal from the charge difference transmitted from the toroidal conductivity controller 22 as a function of time. Once the total milliamp signal reaches a certain maximum point, a “dump and fill” mode is triggered and then entire volume of stripper solution 10 is dumped and replaced by fresh solution.

As shown in FIG. 3, a pump system 40 is operatively coupled to the charge counter device 30 and the stripping solution container 15. The pump system 40 comprises a set of pumps 42A-42H, detectors 44, spray bars 45A, 45B and flow regulators/valves 46A-46G that a) detect hot water flow after a given volume of contaminated stripping solution 10 has been discharged, b) pump and regulate the hot water flow into static mixer, c) simultaneously pump and regulate antifoam compounds into the static mixer, d) simultaneously pump and regulate undiluted resist stripping solution 10 into the static mixer 48, e) direct the resulting stripping solution 10 from the static mixer 48 to the stripper solution container 15.

A level control system 50 is operatively coupled to the pump system 40 and the stripping solution container 15. The level control system 50 is designed to detect and register the volume of stripping solution 10 added to the container 15 and subsequently cut off the flow of solution 10 from the static mixer 48 to the container 15 when the solution 10 in the container 15 is at an appropriate and pre-programmed volume level. The level control system 50 also comprises an automatic control 52 that switches the apparatus from “dump and fill” mode to an “operational mode”.

The speed of the stripping equipment is determined by the resist thickness, temperature of the stripping solution 10, spray pressure of the stripping solution 10, alkali concentration of the stripping solution 10, and total dissolved resist.

A method of monitoring and controlling a resist stripping solution comprises a) obtaining a set of information relating to a surface to be stripped and a resist material, b) providing a sump containing a stripping solution, wherein the stripping solution is prepared according to the set of information in order to react with the resist material, c) controlling the release of the stripping solution onto the surface with a toroidal conductivity controller and a pump system, d) continuously and simultaneously controlling the concentration of the stripping solution with the toroidal conductivity controller, and e) controlling the liquid depth of the stripping solution with a pump system, wherein the pump system can dump used stripping solution from the sump and fill the sump with fresh stripping solution. This method is described below and is also illustrated in the Examples Section that follows.

A contemplated set of information relating to the surface to be stripped and/or the resist materials includes chemical information, chemical or physical makeup/description of the materials on a circuit board or an electronic component, or the chemical composition of the photoresists, the other materials on the substrate or printed wiring board, or information about the stripping solution. Examples of chemical information, makeup or composition data are the a) chemical content of the photoresist, b) substrate information, c) stripper solution content and related information, and d) chemical information regarding the additional layers of materials.

A sump is provided as part of the previously discussed apparatus for controlling and monitoring the stripping solution. The stripping solution, however, is prepared according to the set of information collected in order to react with the resist material. The preparation could include blending different groups of chemicals and stabilizers, keeping the solution at a particular and specific temperature, or blending the solution to comprise a particular pH or solution thickness.

The toroidal conductivity controller, as mentioned earlier, controls both the release of the stripping solution and the concentration of the stripping solution through the measurement of the current or charge difference of the solution versus the original solution and activating a connected pump system. The pump system is also responsible for dumping the used stripping solution once the solution can no longer be restored and filling the sump with fresh stripping solution.

### EXAMPLES

FIG. 3 is a schematic diagram of an apparatus showing a preferred embodiment of the invention. In the diagram, commercial stripping equipment 18 contains a stripper solution 10 and a container 15. (Example of commercial stripping equipment is Chemcut™ Model 547) The stripper 18 operates by pumping stripping solution 10 heated to 125° F. through pumps 42A and 42B through pressure regulating valves 46A, 46B, 46C, and 46D to a set of upper and lower spray bars 45A and 45B. The solution 10 exits the spray bars 45 through nozzles and contacts the printed circuit boards transferring through the conveyorized transport system. As the resist is contacted by the stripping solution 10 the resist starts to swell, then crack, and finally lift off the circuit board and return to the stripping solution sump 15.

The entire time the resist particles are in contact with the stripping solution 10 the particles slowly dissolve taking up additional alkaline reactants. It is therefore desirable to remove the resist particles as quickly as possible after they have been generated. This is accomplished with a solution filtration device. The stripping solution 10 containing un-dissolved resist particles is pumped via pump 42C to a resist separation filter. FIG. 3 also illustrates a belt type resist-removing filter labeled Resist Filter 46E. The resist solution containing undissolved resist particles is sprayed over a moving mesh belt, which separates the resist particles and the stripping solution 10. The filtered resist stripping solution returns to the stripping process tank for reuse. The filtered resist particles move up the belt and are removed by scrapping. The waste resist solution 11 is disposed of in accordance with local, state, and federal waste treatment regulations.

Before the invention can be used, a stripping material must be selected and a series of laboratory and production experiments must be done to obtain the necessary calibration correlation.

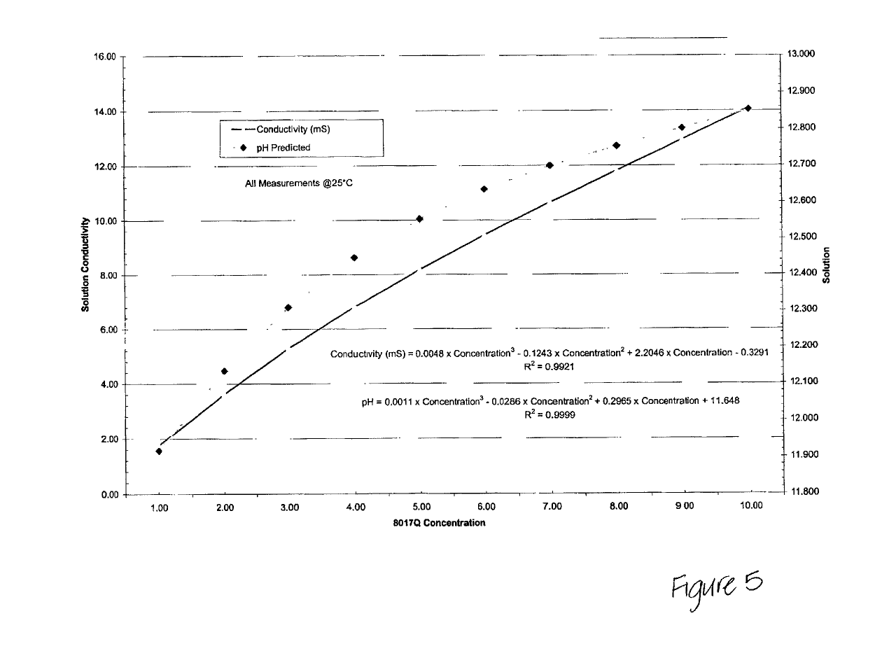

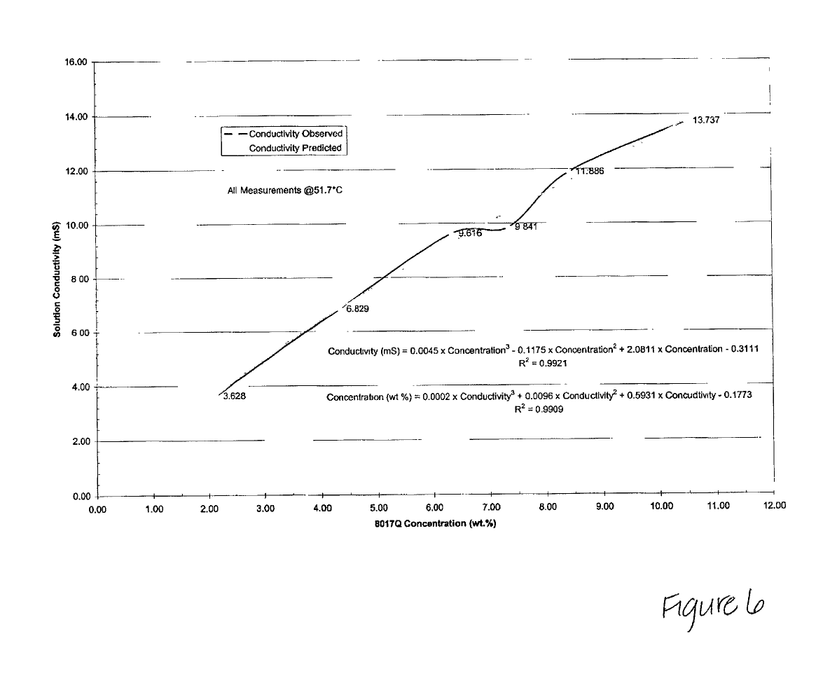

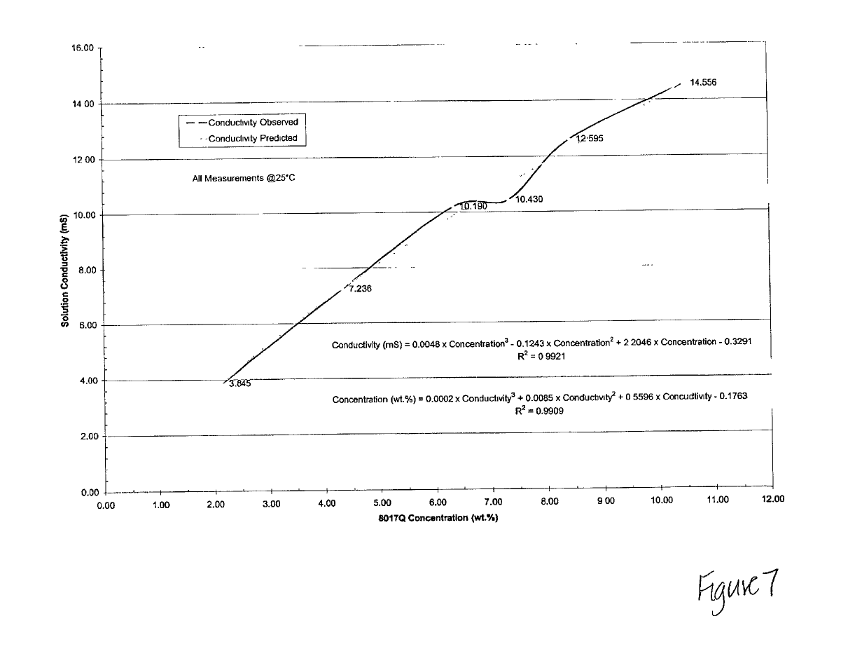

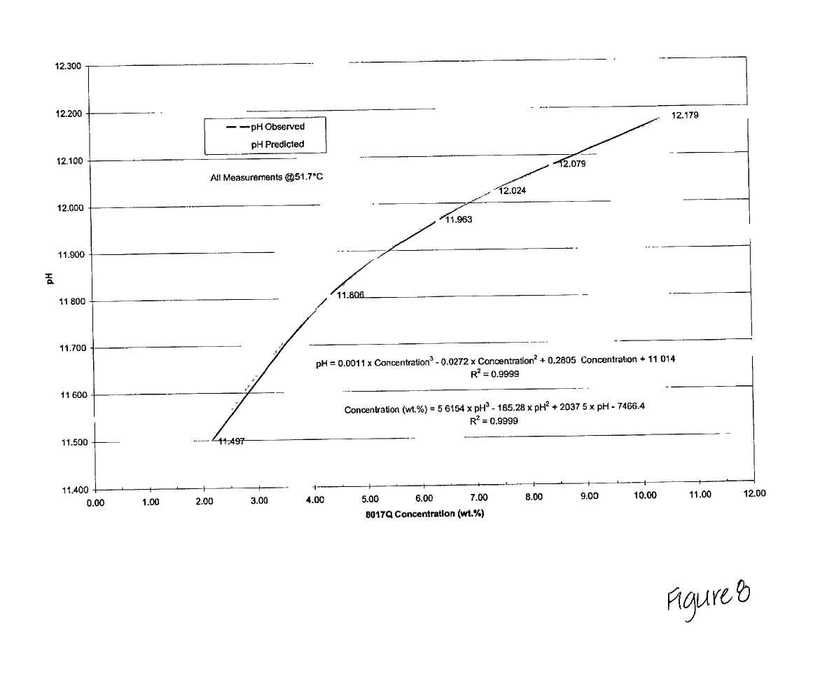

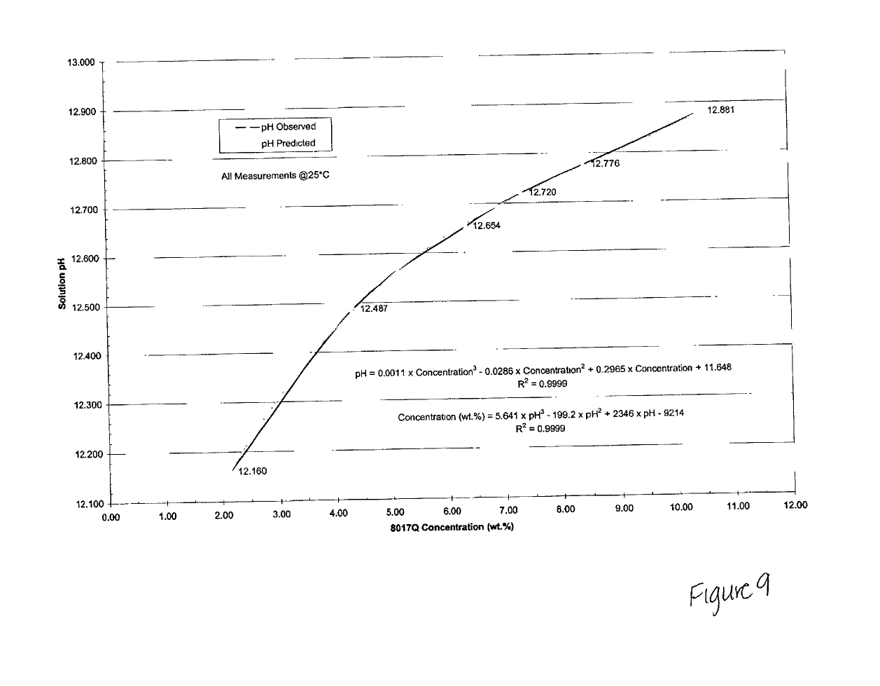

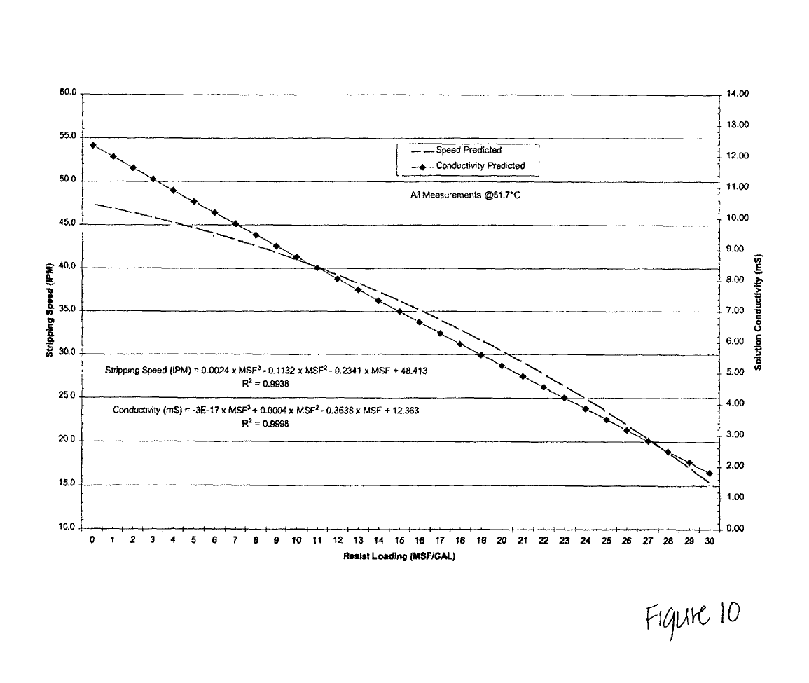

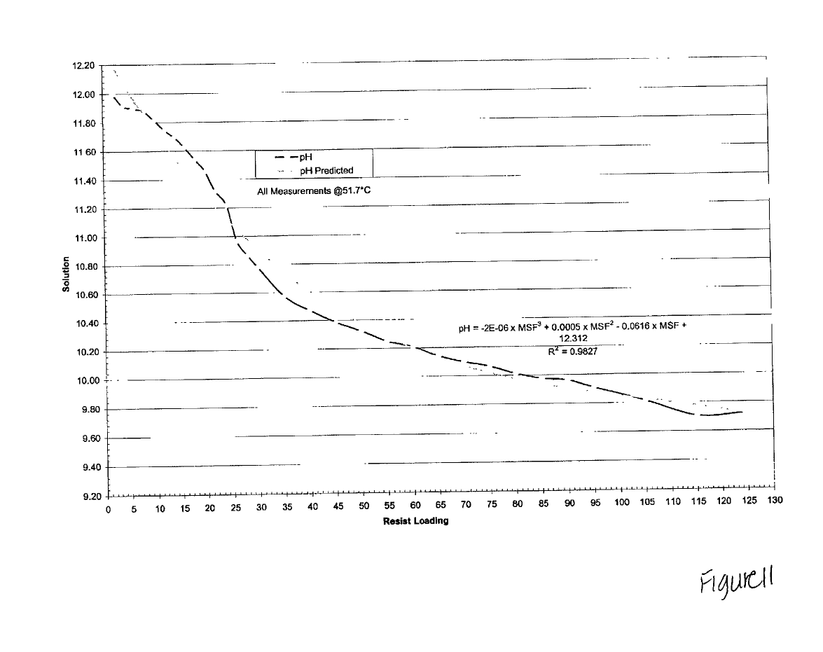

FIGS. 4 and 5 are calibration correlation graphs, which were constructed using a commercially available stripping solution (Electrochemicals™ RS-8017Q) and a commercially available photoresist, (Dupont™ MM120). The experiment was performed in a commercially available resist-stripping machine (Chemcut™ Model 547). This equipment is the actual production equipment. The Electrochemicals™ RS-8017Q material is believed to be an alkaline organic amine aqueous solution containing monoethanolamine (MEA), tetramethyl ammonium hydroxide (TMAH), 2-hydroxyethyl-trimethyl ammonium hydroxide (Choline), methyl alcohol, ethylenediamine, 2-propoxyethanol, or their mixtures. From the Electrochemicals™ product data sheet the operational temperature is either 25° C. or 51.7° C. and the concentration is 7.00%. The solution conductivity and the solution pH were measured in 1.00-% increments over a range of 1.00 to 10.00% in the laboratory. (FIGS. 6-9) The conductivity measurements were made with a Rosemount 54e C toroidal conductivity controller, which is the same instrument, used in this invention.

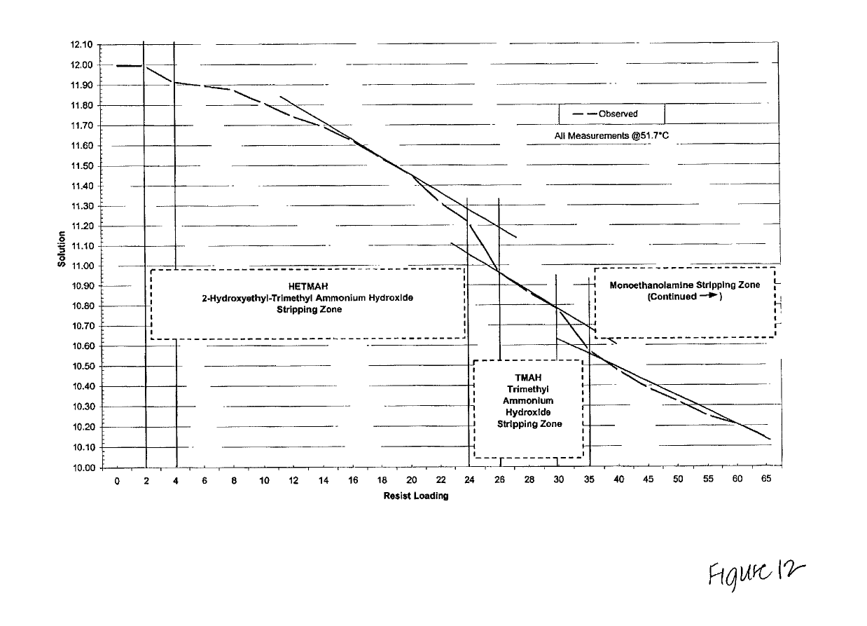

Once the calibration correlation is known, a production test is necessary to determine the resist loading relationship to the resist stripping speed. In FIG. 10, this is a correlation graph, which was constructed using a commercially available stripping solution (Electrochemicals™ RS-8017Q) and a commercially available photoresist, (Dupont™ MM120). The experiment was performed in a commercially available resist-stripping machine (Chemcut™ Model 547). The resist-stripping machine is charged with the required amount of stripping solution 10 and brought up to operational temperature. Given volumes of test printed circuit boards are processed through stripping machine and the stripping speed is recorded. The stripping speed is visually observed and marked by a 65% breakpoint in the stripping chamber. Since the test printed circuit boards are of a known volume of photoresist that is calculated by the length multiplied by width multiplied by thickness to yield a suitable unit of mil square feet. (MSF). The resist loading per gallon of stripping solution 10 is calculated and the stripping speed is correlated (FIGS. 11-16 and Tables 1-3). These calculations will be used later of optimizing the cost of operation.

Incorporated within this invention is the ability for the apparatus to bring the production-manufacturing machine up to operational status automatically without the aid of operators or laboratory personnel. This is accomplished in the following manner. In FIG. 3 the process was begun with the machine cleaned, empty, and ready to bring up to operational status. The apparatus is placed in the auto-fill mode and the liquid level control 50 indicates there is no solution present. The apparatus initiates a hot water fill valve 46E which allows 125° F. water from the circulating hot water heater 52 to flow into a flow regulating device 46. This device sets the maximum flow that hot water can exit the hot water circulating loop. From the flow-regulating device the hot water passes through a helical static mixing device 48. The hot water then empties into and fills the sump 15 of the stripping machine.

At the same time as the hot water is activated, the antifoam chemistry is added by pump 42D. The amount of antifoam chemistry or antifoam agents, such as those agents that are silicon based, that is added is proportional to the rate of water flow. If the hot water flow rate device is set for 20 gallons per minute and the required antifoam chemistry is for example 2.0 milliliters per gallon, then the pump 42D is set for 20 gpm×2.0 ml or 40 ml per minute. The antifoam chemistry/agents 54 is injected into the hot water piping and is mixed via the static mixer 48. The antifoam pump 42D stays activated as long as the hot water valve 46E is initiated. In this fashion the correct amount of antifoam chemistry/agents is automatically added.

At the same time as the hot water and the antifoam chemistry is activated, the undiluted resist stripping chemistry 8 is added proportional to the rate of water flow. If the hot water flow rate device is set for 20 gallons per minute and the required resist stripping chemistry is for example 265 milliliters per gallon, then pump 42D is set for 20 gpm×265.0 ml or 5,300 ml per minute. The resist stripping chemistry is injected into the hot water piping and is mixed via the static mixer 48. The resist stripping chemistry pump 42D stays activated as long as the hot water valve 46E is initiated. In this fashion the correct amount of resist stripping chemistry is automatically added.

As the resist chemistry, antifoam chemistry, and hot water is being mixed and added to the stripper dump, the liquid level control 50 is monitoring the level. When the level reaches the desired operating level the liquid level control 50 stops the auto-fill mode. Next the apparatus is switched to pre-operational mode and the circulation pump 42F is activated, which begins circulating the stripping solution.

After the solution has been circulating for about a minute the apparatus checks the operational temperature. If the operational temperature is within operational limits, the apparatus unlocks the toroidal conductivity controller to measure and adjust the alkaline organic amine concentration to the specified set point. If the alkaline reactant concentration is below the set point, pump 42G is activated and begins pumping concentrated resist stripping chemistry into the working stripping solution proportional to the deviation from the set point. If the alkaline reactant concentration is above the set point, hot water valve 46E is activated to add hot water to the working stripping chemistry proportional to the deviation from the set point.

The pump 42F continuously circulates stripping solution 10 through the toroidal conductivity controller sensor 24 that measures real time the alkaline organic amine concentration. The concentration is displayed as a percent concentration on the display 26 of the toroidal conductivity controller 22.

After the alkaline organic amine concentration has been adjusted to the set point, the operational temperature is within the specified range; the apparatus switches to operational mode. In operational mode all the normal machine functions of the commercially available stripping unit are operational.

In the normal operation of the printed circuit board stripping machine, the printed circuit boards enter the stripping machine and stripping solution is sprayed on the circuit boards. Contact of the stripping solution and the photoresist causes the photoresist to swell, rupture, then lift-off the circuit board. The resist that has separated is washed into the stripping machine dump where it is subsequently either dissolved or removed via the Resist Filter 46E.

As the alkaline reactant concentration is lowered due to reaction with the photoresist, the toroidal conductivity controller 22 senses the reduction in alkaline reactant concentration and makes concentrated stripping solution 10 additions to maintain the alkaline reactant concentration set point. As the photoresist dissolves in the stripping solution 10, the speed at which the photoresist strips off is reduced, independent of the alkaline reactant concentration. This is known as resist loading. To offset this action, a volumetric dilution of active stripping solution 10 must be made to keep the photoresist stripping speed constant.

To keep the photoresist stripping speed constant, you must know how much photoresist has dissolved in the active stripping solution. The apparatus described in this invention has incorporated a unique method of solving this problem. Since, the alkali in the stripping solution and the photoresist chemically react, a known amount of alkali reactant dissolves a known amount of photoresist in mil square feet units. This information is generally given with commercially available stripping solutions. If the information is not available it can be derived empirically in laboratory experimentation. (Example: 1 gallon of concentrated Electrochemicals™ RS-8017Q will strip 1200-1800 MSF of photoresist.) From laboratory experimentation with Electrochemicals™ RS-8017Q resist strip and DuPont™ MM120 photoresist it was derived that 1 gallon of concentrated RS-8017Q would dissolve 1500 MSF of MM120 photoresist. In other words, each gallon of resist stripping concentrate that is pumped through pump 42G will dissolve 1500 MSF of photoresist.

Pump 42G is activated via a 4-20 mamp signal from the toroidal conductivity controller. This signal is proportional to the deviation of the controller set point. The apparatus described in this invention incorporates a milliamp-totalizing counter that accumulates the total millamp signal that has been sent from the toroidal conductivity controller. Since the pump 42G pumps a known volume of stripping solution proportional to the milliamp signal received, by totalizing the milliamp signal you know exactly how much concentrated material has been consumed, therefore you know how many MSF of photoresist has been loaded into solution. The unit of photoresist loading is MSF/Gallon of stripping solution.

As the photoresist loading level increases, the milliamp totalizer/charge counter device 30 is set to a predetermined set point. The set point is derived by the slowest speed that the photoresist machine can economically be operated containing the highest loading of dissolved photoresist. This is optimized for maximum operational efficiency and minimal operational cost.

Assume the milliamp totalizer/charge counter device 30 is set for 5000 milliamps, which equates to 9.0 MSF/GAL resist loading. As the milliamp totalizer hits the 5000 milliamp set point, the apparatus switches to dump and fill mode. The resist stripping solution discharge device, valve 46F is activated and resist stripping solution from the stripping solution dump is discharged to a drain leading to the appropriate waste treating operation. As the level of the resist stripping solution is lowered in the stripping solution dump, a level control 50, monitors the resist stripping solution level. When a given volume of stripping solution has been discharged, the level control 50 closes the solution discharge valve 46F and initiates the hot water fill valve 46E which allows 130° F. water from the circulating hot water heater 52 to flow into a flow regulating device 46. This device adjusts the maximum flow that hot water can exit the hot water circulating loop. From the flow-regulating device the hot water passes through a helical static mixing device 48. The hot water then empties into and fills the dump of the stripping machine. At the same time as the hot water is activated, the antifoam chemistry and resist stripper are activated or turned on again.

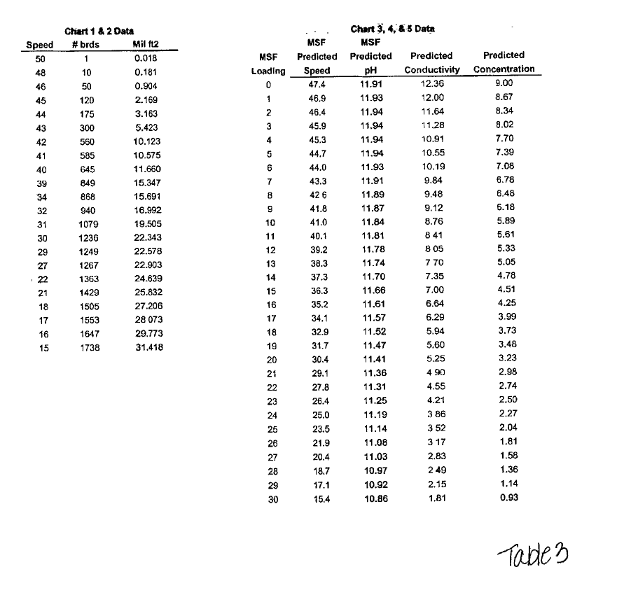

As the solution level rises in the stripping solution dump, the level control 50 detects the correct operating solution level and switches from dump and fill mode to normal operational mode. The apparatus resets the first milliamp totalizer to 0 and switches to a second milliamp totalizer that is set for the difference in how much the resist loading was reduced. The first milliamp totalizer determines the maximum resist loading in MSF, for example 10.0 MSF/GAL. Assume that 24 gallons of stripping solution was discharged and 24 gallons of hot water was added. This reduced the resist loading to 8.0 MSF/GAL resist loading. The second milliamp totalizer would be set for 1000 milliamps or 2.0 MSF/GAL resist loading. In this fashion the resist loading would be held constant between 10.0-8.0 MSF/GAL, as shown graphically in FIG. 17. This illustration shows a constant resist loading input and how the system operates at the control level.

In printed circuit board manufacturing, the use of multi-thickness photoresists is quite common. This especially applies to selective metal plating applications. This would mean that the photoresist amount (MSF) would vary from job to job. Since the invention described herein is capable of detecting the total amount of alkali chemistry consumed, the use of multi-thickness resist presents no problems.

The use of the apparatus described results in increased operational uptime and minimizes the total manufacturing cost. By applying the invention in the manufacture of printed circuit boards or the like, the alkaline organic amine concentration and the dissolved resist concentration in the resist stripping solution are always monitored and controlled with the desired target range, and continuous operation is possible for a long period at a stable level. Since the quality of the resist stripping solution can be controlled constantly, the resist stripping performance on the printed circuit board is stable, comprehensive effects are achieved, including a significant saving of consumption of solution, rise of yield, decrease of down time, and reduction of labor cost.

Therefore, among other things, the present subject matter can a) logically determine the proper combination of materials for a suitable stripper solution depending on the needs of the customer, b) operate an efficient and reliable apparatus for stripping photoresists using the formulated stripping solution and c) simultaneously, consistently and automatically control the formulated stripping solution based on a set of predetermined parameters.

Thus, specific embodiments and applications of apparatus and methods involving resist stripping and stripping solutions have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An apparatus for monitoring and controlling a stripping solution comprising:
a sump containing a stripping solution;
a toroidal conductivity controller system that controls the sump;
a charge counter device coupled to the controller;
a pump system operatively coupled to the charge counter device; and
a level control system operatively coupled to the pump system and the sump.

2. The apparatus of claim 1, wherein the stripping solution comprises at least one of monoethanolamine (MEA), tetramethyl ammonium hydroxide (TMAH), 2-hydroxyethyl-trimethyl ammonium hydroxide (Choline), methyl alcohol, ethylenediamine, 2-propoxyethanol, or their mixtures.

3. The apparatus of claim 1, wherein the stripping solution consists of monoethanolamine (MEA), tetramethyl ammonium hydroxide (TMAH), 2-hydroxyethyl-trimethyl ammonium hydroxide (Choline), methyl alcohol, ethylenediamine, 2-propoxyethanol, and their mixtures.

4. The apparatus of claim 1, wherein the charge counter device accumulates the total milliamp signal that has been sent from the toroidal conductivity controller system.

5. The apparatus of claim 1, wherein the toroidal conductivity controller system comprises a controller, a toroidal conductivity sensor and a display device.

6. The apparatus of claim 5, wherein the sensor monitors a conductivity of the solution.

7. The apparatus of claim 6, wherein the toroidal conductivity controller is operatively coupled to the sensor.

8. The apparatus of claim 7, wherein the sensor is operatively coupled to the display device.

9. The apparatus of claim 5, wherein the sensor comprises an electrodeless conductivity sensor.

10. The apparatus of claim 1, wherein the pump system comprises at least one of a pump, a valve, a flow regulator and a resist filter.

11. The apparatus of claim 1, wherein the level control system further comprises an automatic control to switch the apparatus from one mode to another mode.

12. The apparatus of claim 11, wherein the automatic control switches the apparatus from dump and fill mode to operational mode.

13. A method of monitoring and controlling a resist stripping solution, comprising:
obtaining a set of information relating to a surface to be stripped and a resist material;
providing a sump containing a stripping solution, wherein the stripping solution is prepared according to the set of information;
controlling the release of the stripping solution onto the surface with a toroidal conductivity controller and a pump system;
controlling the concentration of the stripping solution with the toroidal conductivity controller; and
controlling the liquid depth of the stripping solution with a pump system, wherein the pump system dumps the stripping solution from the sump and fills the sump with a fresh stripping solution.

14. The method of claim 13, wherein the set of information comprises chemical information, a chemical or a physical description of the materials on a circuit board or an electronic component, or chemical composition of a photoresist material.

15. The method of claim 13, wherein the stripping solution comprises at least one of monoethanolamine (MEA), tetramethyl ammonium hydroxide (TMAH), 2-hydroxyethyl-trimethyl ammonium hydroxide (Choline), methyl alcohol, ethylenediamine, 2-propoxyethanol, or their mixtures.

16. The method of claim 13, wherein controlling the release of the stripping solution comprises totalizing the milliamp signal to determine the photoresist amount that has been loaded into the solution.

17. The method of claim 13, wherein controlling the concentration of the stripping solution comprises:
totalizing the total milliamp signal sent from the toroidal conductivity controller until the total milliamp signal reaches a predetermined set point;
activating a dump and fill mode when the total signal reaches the predetermined set point.

18. The method of claim 13, wherein the toroidal conductivity controller comprises a controller, a toroidal conductivity sensor and a display device.

19. The method of claim 18, wherein the sensor monitors a conductivity of the solution.

20. The method of claim 13, wherein the pump system comprises at least one of a pump, a valve, a flow regulator and a resist filter.
